(19) United States
(12) Patent Application Publication
(10) Pub. No.: US 2016/0283650 A1
(43) Pub. Date: Sep. 29, 2016

(54) METHOD FOR IDENTIFYING SYNTHETIC LETHALITY

(71) Applicant: THE TRUSTEES OF COLUMBIA UNIVERSITY IN THE CITY OF NEW YORK, New York, NY (US)

(72) Inventors: Alexandra Jacunski, New York, NY (US); Nicholas Tatonetti, New York, NY (US)

(21) Appl. No.: 15/055,319

(22) Filed: Feb. 26, 2016

Related U.S. Application Data
(60) Provisional application No. 62/121,163, filed on Feb. 26, 2015.

(51) Int. Cl. G06F 19/12; G06F 19/00

(52) U.S. Cl. CPC G06F 19/12; G06F 19/3437; G06F 19/345

(57) ABSTRACT

Techniques for predicting synthetic lethality in a first species using experimentally derived interactions from at least a second species. An example method can include generating a first biological network for the first species and a second biological network for the second species that include node information representing genes and edge information representing physical interactions between gene-protein products. The method can include determining and normalizing one or more network parameters to permit comparisons between the first and second biological networks. The method can further include training a synthetic lethality model with the experimentally derived synthetic lethality data and applying the synthetic lethality model to the first biological network to predict one or more synthetic lethality pairs.

### CROSS-REFERENCE TO RELATED APPLICATIONS

This application claims priority to U.S. Provisional Application Ser. No. 62/121,163 filed on Feb. 26, 2015, which is incorporated by reference herein in its entirety.

### STATEMENT REGARDING FEDERALLY SPONSORED RESEARCH

This invention was made with government support under Grant No. R01GM107145 awarded by the National Institute of General Medical Sciences. The government has certain rights in the invention.

### BACKGROUND

Synthetic lethality (SL) can occur when two nonessential genes cause cellular inviabililty when knocked out simultaneously. SL pairs can change between environments such as disease and therapy. Drugs can mimic genetic knock-out effects. The understanding of promiscuous drugs, polypharmacology-related adverse drug reactions, and multi-drug therapies, especially cancer combination therapy, can be informed by an improved understanding of synthetic lethality.

However, SL analysis applied to humans can face certain challenges, due at least in part to ethical issues, limited available drug lines, and experimental burden. Applying information obtained from SL analysis of well-studied model organisms, such as yeast, to humans can in principle overcome at least some of these challenges, but certain attempts to do so have been unsuccessful.

Accordingly, there is a need for a method for identifying SL that reduces experimental burden.

### SUMMARY

The presently disclosed subject matter provides techniques for identifying SL. Exemplary methods can use biological networks of two species as a model framework and can translate the parameters so that both networks can be compared. As such, a model can be constructed on one species and applied to another, despite the two species having different biological networks.

According to one aspect of the disclosed subject matter, methods for predicting SL in a first species using experimentally derived synthetic lethality data of at least a second species is provided. An example method can include generating a first biological network for the first species and a second biological network for the second species. Each of the first and second biological networks can include node information representing genes and edge information representing physical interactions between gene-protein products.

The method can include determining one or more network parameters of the first and second biological networks and normalizing the one or more network parameters to permit comparisons between the first and second biological networks. The normalizing can include rank-normalization. The method can include training a synthetic lethality model with the experimentally derived synthetic lethality data and applying the synthetic lethality model to the first biological network to predict one or more synthetic lethality pairs.

Training can include selecting one or more synthetic lethality pairs and one or more non-synthetic lethality pairs based on the experimentally derived synthetic lethality data. Training can further include modeling synthetic lethality from the selected pairs using random forest classification and cross-validating the modeling. In some embodiments, the first and second biological networks can include protein-protein interaction networks. The second species can be S. cerevisiae. In some embodiments, the first species can be S. pombe. In some embodiments the first species can be mouse. In some embodiments, the first species can be human.

According to another aspect of the disclosed subject matter, methods for selecting cancer drug treatment for a patient are provided. An example method can include selecting at lease a source species with experimentally derived synthetic lethality data. The method can further include generating a first biological network for the source species and a second biological network for the patient. Each of the first and second biological networks can include node information representing genes and edge information representing physical interactions between gene-protein products. The method can include determining one or more network parameters of the first and second biological networks and normalizing the one or more network parameters to permit comparisons between the first and second biological networks. The normalizing can include rank-normalization.

The method can include training a synthetic lethality model with the experimentally derived synthetic lethality data and applying the synthetic lethality model to the second biological network to predict one or more synthetic lethality pairs. The method can further include filtering the one or more synthetic lethality pairs to generate one or more context specific synthetic lethality pairs based on protein expression data of a cancer cell line targeted by the cancer drug treatment and choosing one or more drugs that target gene expression products of at lease one of the one or more context specific synthetic lethality pairs.

In some embodiments, the first and second biological networks can include protein-protein interaction networks. The second species can be S. cerevisiae.

### BRIEF DESCRIPTION OF THE DRAWINGS

FIG. 1 provides a flow chart of an exemplary method in accordance with the disclosed subject matter.

FIG. 2A-FIG. 2D illustrate the prediction of synthetic lethality in S. pombe using S. cerevisiae as the source species.

FIG. 3A-FIG. 3C illustrate relationships between protein complexes and putative synthetic lethal pairs.

FIG. 4 illustrates SL prediction using aspects of the disclosed subject matter scores in relation to the DAISY and Syn-Lethality datasets.

FIG. 5 illustrates the landscape of human synthetic lethality.

FIG. 6 illustrates the function-specific patterns of synthetic lethality.

FIG. 7A-FIG. 7D illustrate connection between predicted synthetic lethal pairs and cancer therapy.

FIG. 8A-FIG. 8T provide exemplary data demonstrating drug synergy.

### DETAILED DESCRIPTION

The presently disclosed subject matter provides methods for identifying SL. Exemplar methods can use the biological network connectivity profiles between genes to characterize their potential for an SL relationship. In certain embodiments, the disclosed subject matter can use protein-protein interaction (PPI) networks of two species as a model framework and can translate the parameters so that both networks can be compared. As such, a model can be constructed on a source species and applied to a target species, even if the two species have incomparable biological networks.

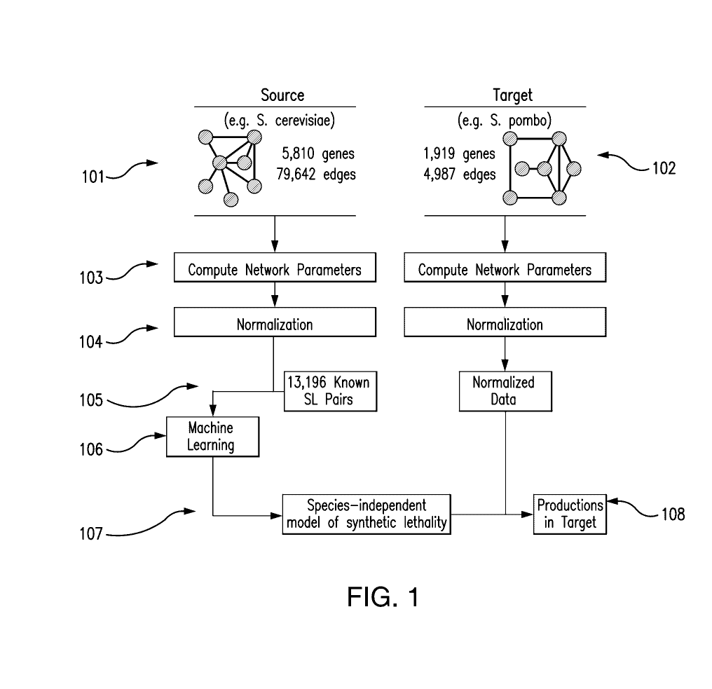

For the purpose of illustration and not limitation, FIG. 1 shows an exemplary flow chart of a method in accordance with the disclosed subject matter. In certain embodiments, the method involves predicting SL pairs in a target species 102 using the known SL pairs 105 of at least a source species 101. The method can further include generating biological networks for the species and network parameters 103 to describe connectivity profiles. In certain embodiments, the method can include normalization 104 of the network parameters to permit comparisons. In certain embodiments, the method can include training a species-independent model of synthetic lethality 107 through machine learning 106 using the known SL pairs 105 of the source species 101. The method can further include applying the synthetic lethality model to the normalized target networks to predict one or more synthetic lethality pairs 108.

In certain embodiments, a source species 101 can be chosen based on the abundance of known SL information. For example, SL is well studied in S. cerevisiae with 13, 196 known SL pairs. A target species 102 can be a species of interest, for example, S. pombe, mice, or human.

Two proteins can be considered as being connectivity homologous if they share similar connectivity profiles in their respective networks. A connectivity homologous relationship can exist between two proteins in the same species, or between proteins of different species. This can be generalized for pairs of proteins, or groups of proteins (i.e. modules). For example, two pairs of proteins can be connectivity homologous because both pairs are connected to each other in a similar way. Prediction of SL can use the connectivity homology.

Connectivity profiles can be represented by vectors of network parameters. For example, each gene can be represented by a vector of eight parameters. Each gene pair can be represented by a vector of four node-pair parameters as well as the individual profiles for each gene in the pair, leaving each pair with a connectivity profile defined by 20 network parameters. Such network parameters are illustrated in Table 1, where the parameter importance is measured using the well-known Gini importance in the NetworkX Python package.

TABLE 1

| | | | Parameter |
|---|---|---|---|
| Parameter | Context | Description | Importance |
| 2^{nd} degree | Single | The sum of all nodes two | 0.036, 0.030 |
| shared | node | edges away from the node | |
| neighbors | | of interest. | |
| Betweenness | Single | The sum of the fraction of | 0.056, 0.056 |
| centrality | node | shortest paths between two | |
| | | other nodes passing through | |
| | | the node of interest. | |
| Closeness | Single | The inverse sum of all shortest | 0.035, 0.032 |
| centrality | node | paths that originate at the | |
| | | node of interest. | |
| Communi- | Node pair | The sum of all closed walks | 0.043 |
| cability | | between a pair of nodes. | |
| Current-flow | Single | Analogous to betweenness | 0.057, 0.045 |
| betweenness | node | centrality, but with all | |
| centrality | | paths instead of shortest | |
| | | paths. Also known as random | |
| | | walk betweenness centrality. | |
| Degree | Single | The fraction of edges a node | 0.074, 0.055 |
| centrality | node | has of all possible edges. | |
| Eccentricity | Single | The maximum distance from the | 0.038, 0.035 |
| | node | node of interest to any other | |
| | | node in the network. | |
| Eigenvector | Single | The eigenvector for the | 0.042, 0.034 |
| centrality | node | largest eigenvalue of the | |
| | | matrix adjacency network. | |
| Inverse | Node pair | The inverse of the smallest | 0.048 |
| shortest | | number of edges connecting | |
| path | | two nodes of interest. | |
| PageRank | Single | The rank of graph's nodes | 0.080, 0.072 |
| | node | based on the number of | |
| | | incoming links. | |
| Shared | Node pair | The intersection of two nodes' | 0.067 |
| neighbors | | sets of immediate neighbors. | |
| Shared | Node pair | The number of nodes that are | 0.063 |
| non- | | not immediate neighbors of | |
| neighbors | | both nodes of interest. | |

In certain embodiments, the biological networks can include protein-protein interaction (“PPI”) networks. PPI data are available across many species. For example, PPI network parameters and connectivity profiles can be determined on the base of experimental data from the BioGrid, which contain 5,810 nodes(N)/79,642 edges (E) for S. cerevisiae; 1,919N/4,987E for S. pombe; 4,233N/9,369E for M. musculus; and 14,820N/126,484E for H. sapiens. Each node represents a gene, while edges represent a physical interaction between gene protein products. In certain embodiments, the networks can be pruned to contain one connected component by first visualizing them in Cytoscape and identifying islands. With reference to FIG. 1 for illustration but not limitation, determination of network parameters 103 can be carried out separately for the source species 101 and target species 102. In certain embodiments, the commercially available NetworkX (version 1.8.1) package for Python can be used to calculate network parameters except shared neighbors, shared non-neighbors, and shared 2nd-degree neighbors, which can be determined from adjacency matrices for each network.

The distributions and ranges of network parameter values can differ between species. To correct for these differences, each network can be normalized to rescale the values of each parameter between 0 and 1. For illustration but not limitation, four example normalization strategies are described in Table 2.

TABLE 2

| Method | Description |
|---|---|
| Normalization | Each value is divided by the maximum occurring |
| | value of the parameter |
| Rank- | Each value is ranked from smallest to largest, |
| normalization | with tie breaks at random in case of equal |
| | values. These are then divided by the total |
| | number of values. |
| Tied-rank | Each value is ranked from smallest to largest; |
| normalization | entries with the same value are given the |
| | average of all their ranks. These are then |
| | divided by the total number of values. |
| Quantile | Parameter values are collected for two or more |
| normalization | conditions. Values are ranked for each |
| | condition. The values are then sorted, and |
| | each row is averaged. These values are then |
| | sorted back into order according to rank. |

Regular normalization of a parameter returns each value divided by the maximum value of that parameter, such that each value is between 0 and 1. Rank-normalization of data for a given species involves calculating individual single- and two-node parameters. Then, for each parameter, calculated values can be ranked from the smallest to the largest, resolving ties at random. Rank-normalization further includes dividing all values by the total number of genes in the network (for single-node parameters) or the total number of gene pairs (for node-pair parameters). This results in genes or gene pairs having parameter values be a value between 0 and 1. Tied-rank normalization assigns the median rank to equal values, then normalizes single-node parameters by the number of genes in the network, and node-pair parameters by the total number of pairs. Quantile normalization can be used where networks with fewer nodes/edges are up-sampled. Normalization can make parameter values comparable between species. The normalized data can be referred to as being “translated.”

In certain embodiments, entropy analysis can be performed to verify that parameter translation enables the interspecies comparison. Normalization does not necessarily account for differences in overall network structure; for example, if two parameters are perfectly correlated in one species network and perfectly anti-correlated in another, normalization methods would not be appropriate, and models would not be translatable. Entropy can be measured by clustering genes from the source and target species using vectors of their network parameter values. Without normalization, the genes can segregate by species, corresponding to low entropy. Successfully translated or normalized network parameters, however, exhibit mixing between species and therefore higher entropy.

In certain embodiments, logistic regression (LR) can be used to train models of synthetic lethality based on known SL pairs. In certain embodiments, random forests (RF) can be used to train models of synthetic lethality based on known SL pairs. In certain embodiments, SL pairs can be selected based on SL data, e.g., from the well-known BioGrid. Based on BioGrid, S. cerevisiae have over 14,000 unique SL pairs and S. pombe have over 700, while Mus musculus and Homo sapiens have 14 and 1 pairs, respectively. Pairs not explicitly labeled as SL can be considered non-synthetic lethal (NSL) pairs and can be randomly selected as negative training examples. Although treating any pair without experimental evidence for synthetic lethality as NSL can be incorrect for certain pairs that are SL but have not yet been investigated, this error is negligible due to the rarity of SL interactions (estimated 0.1% in dipoid organisms). In certain embodiments, SL and NSL pairs can be selected in a ratio of 1:5. From the selection, a five-fold cross-validation can be performed by randomly selecting 1/5 of the data on which to train classifier, and testing the model on the remaining 4/5.

In certain embodiments, the classifiers can be trained on raw/untranslated network parameters. In certain embodiments, the classifiers can be trained on normalized/translated network parameters. Such classifiers can then be applied to the target species with normalized network parameters, providing scores between 0 and 1. While a score ≧0.5 can be considered SL by model parameters, the cutoff value at which a gene pair is considered as SL can be adjusted for different applications or purposes. A higher score correlates to the greater evidence of SL according to the model.

Network size does not necessarily affect translatability. Species-specific PPI networks can vary in their completeness, which can be approximated by network density. S. cerevisiae have one of the most complete PPI networks (density=0.04 in the above mentioned data), while those of S. pombe, M. musculus, and H. sapiens are less complete, with densities of approximately 0.02, 0.01, and 0.01, respectively. To illustrate that network completeness will not factor into the SL predictions, S. cerevisiae networks are ablated to 10, 20, 30, 40, 50, 60, 70, 80, and 90% of its original size by removing edges from the original network, where highly researched interactions (those that appear in BioGrid multiple times) can be more likely to be removed. The network parameters (raw and rank-normalized) are then calculated for each network.

A random forest classifier can be trained based on the complete S. cerevisiae network as the source by using known SL pairs and five times as many NSL pairs. Applying the trained classifier to each ablated network in turn, the success of the translation can be evaluated using the AUROC. While performance of the translational model drops as the network is ablated when both untranslated and translated parameters are used, using untranslated parameters decreases model performance more quickly and to a higher degree than using translated parameters. When using rank-normalization, the AUC drops by less than 0.1 when depleting the network by 80%, which has a lower density than those of either the mouse or human networks. Thus network density does not significantly affect transferability.

Furthermore, node popularity does not affect prediction of synthetic lethality. There is potential bias as higher degree nodes are more likely to be studied, and more popularly studied genes can be more likely to be synthetic lethal. To understand this potential bias, a normalized popularity (degree/popularity) can be defined, where popularity is the number of times a particular gene appears in the BioGrid database. While a score can be correlated with degree and, thus, popularity, it is not correlated with normalized popularity. Further, the predictive performance of the disclosed subject matter is independent of each of the three measures (degree, popularity, and node popularity) according to ANOVA.

The disclosed subject matter can further involve predicting context-specific synthetic lethality. Biological contexts, such as tissue type and disease state, can influence synthetic lethal interactions. In certain embodiments, predictions for a given cell or tissue can be customized for a specific context by pruning away any predicted genes that are known not to be expressed in the given context. For example, the Protein Atlas can be used to perform this customization to filter SL pairs in human. Certain tissues and cell types have significantly more SL pairs filtered, suggesting such tissues are not as susceptible to SL reactions.

Following examples using S. cerevisiae as the source species further illustrate the principles and applications of the disclosed subject matter.

### EXAMPLE 1

### Prediction of Synthetic Lethality in S. Pombe

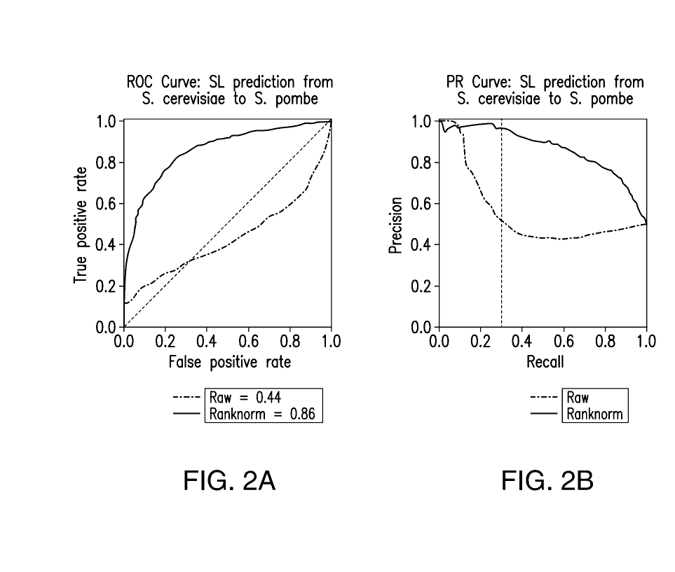

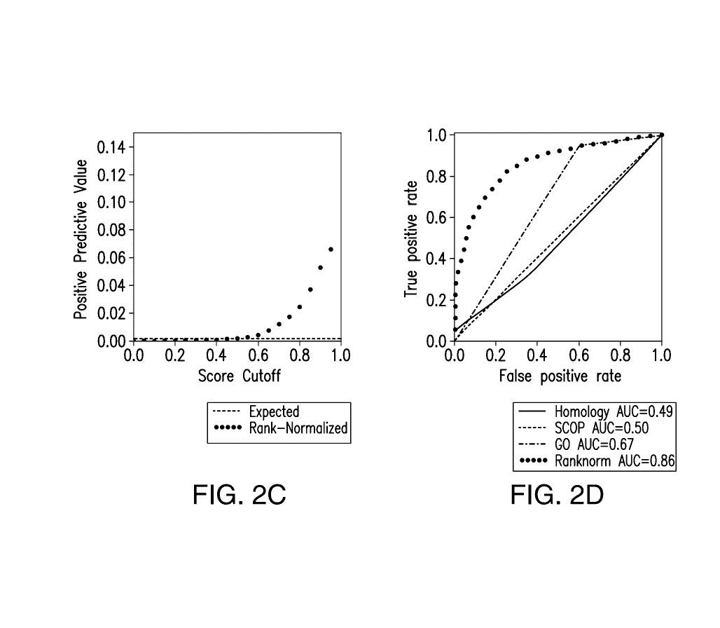

With S. pombe as the target (628 known SL pairs), using untranslated parameters results in poor between-species SL prediction and establishes a baseline for comparison (AUC=0.44). Normalization can improve the model for SL prediction. Rank normalization performed most consistently (AUC=0.86; p<2.2e−16, De Long's method) (FIG. 2A). Unless otherwise noted, rank normalization will be used in all the examples for illustration.

At 30% recall, the normalized parameters can improve precision from 50% to 98% (FIG. 2B). The positive predictive value (PPV) from between species translation decreases slightly from that observed in within-species classification (FIG. 2C), but significantly improves over chance (X2=269868.6, p<0.01 at score ≧0.85). For example, at a score of 0.85, the PPV is approximately 0.04—forty times higher than expected by chance. It increases to 0.07 at a cutoff of 0.95, a 70-fold increase.

Methods in accordance with the disclosed subject matter are compared to four other methods to predict SL: protein homology, structural classification, functional annotations, or univariate connectivity. Protein homology, structural classification, and functional annotations achieved AUCs of 0.49, 0.50, and 0.67, respectively, for inter-species prediction (FIG. 2D). In each case, the disclosed subject matter performs better (p<0.0001, DeLong's method, all comparisons). There is no significant predictive performance from the univariate connectivity model (Mann-Whitney U=1,201, p=0.43).

### EXAMPLE 2

### Prediction of Synthetic Lethality in Mice

The trained model using S. cerevisiae as the source species can be applied to M. musculus as the target species. Of the nine mouse SL pairs recorded in BioGrid, 8 are predicted to be SL with a score ≧0.5; five have scores ≧0.70. SL prediction achieves an AUC of 0.988. In contrast, a trans-species prediction of SL using Gene Ontology (GO) similarity achieves an AUC of 0.69.

### EXAMPLE 3

### Prediction of Synthetic Lethality in Human

The SL model trained on S. cerevisiae can be applied to human network parameters and generate a score between 0 and 1 for all human gene pairs. A database of severe, tolerated, homozygous, deleterious co-mutations can then be compiled. These occur when at least one patient is homozygous for a deleterious mutation in both genes of a given pair in either of two datasets (1000 Genomes, and Sweden-Schizophrenia Population-Based Case-Control Exome Sequencing (dbGaP accession: phs000473.v1.p1). Evaluation of all gene pairs shows 450,010 pairs that match these criteria (0.4% of all possible pairs). On average, these gene pairs had significantly lower scores (median score=0.116) versus all gene pair scores (median=0.122; Mann Whitney U=98,055,441,225.5, p<2.2e10-16). After filtering these pairs from the SL predictions as false positives and using a score cutoff >0.85, the false discovery rate (FDR) from this filtering is determined to be 0.36% (61 false positives to 16,886 true positives).

Putative synthetic lethal pairs are more likely to be in the same pathway. This is supported by the predicted human SL pairs using KEGG annotations. Gene pairs with scores >0.95, 0.90, and 0.80 were all significantly enriched for intra-pathway interactions compared to pairs selected at random (p<2.2e−16, Fisher's exact test, all cutoffs). The ten highest-scoring gene pairs with the same pathway annotation are shown in Table 3.

TABLE 3

| Gene 1 | Gene2 | Score | Pathway Name |
|---|---|---|---|
| KYNU | SMS | 0.990 | Tryptophan |
| KYNU | GSR | 0.987 | Tryptophan |
| SOS1 | BCR | 0.986 | MAPK signaling |
| MSH3 | PMS2 | 0.986 | Mismatch repair |
| RCOR1 | REST | 0.985 | Huntington's |
| BIRC5 | CASP9 | 0.985 | Pathways in |
| KYNU | NAGK | 0.984 | Tryptophan |
| POLR1B | POLR1A | 0.980 | Purine metabolism |
| RIPK1 | RIPK3 | 0.980 | Apoptosis |
| MAPK9 | MAP2K7 | 0.980 | MAPK signaling |

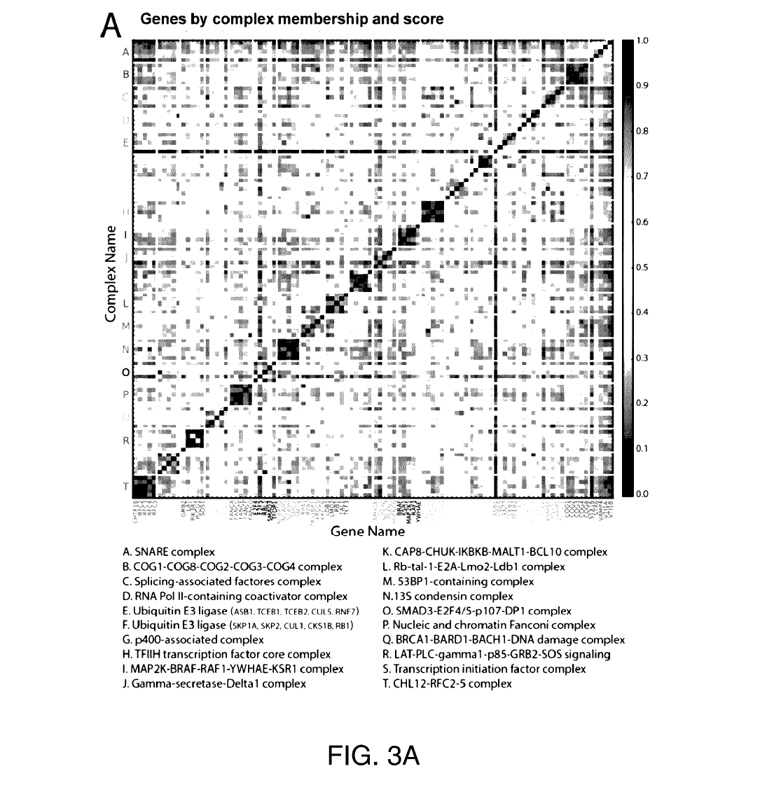

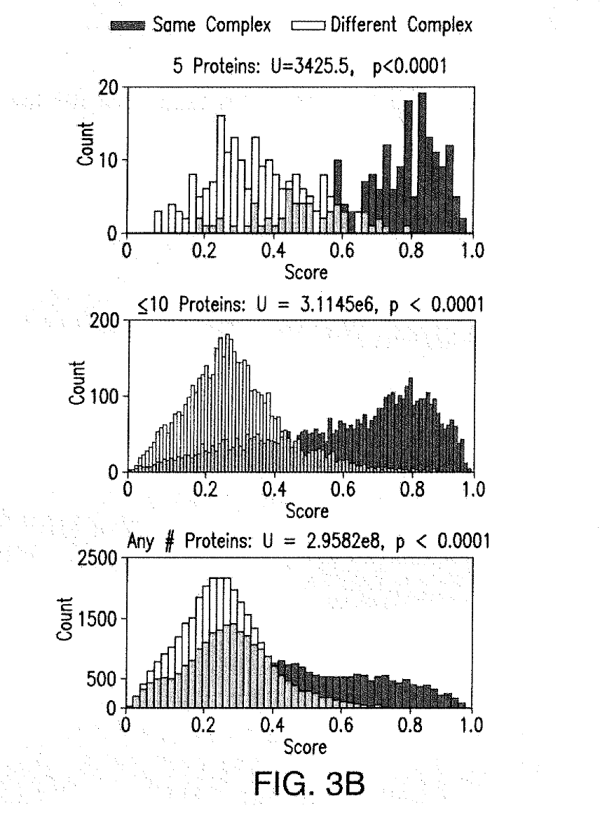

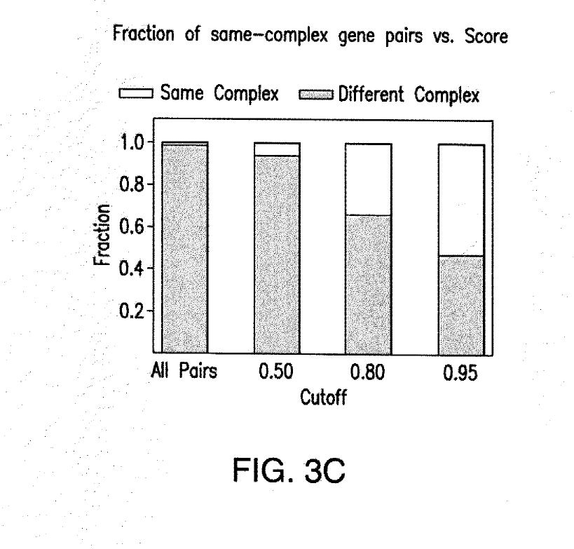

Protein complexes are significantly enriched for putative synthetic lethal pairs. A protein complex can be functional with one deleteriously mutated component, but present a lethal phenotype with two such mutations. The SL analysis results corroborate this pattern. Using randomly selected 20 sets of mutually exclusive protein complexes with five subunits from the Comprehensive Resources of Mammalian Protein Complexes (CORUM), the scores of all the associated genes can be determined and plotted as a heat map (FIG. 3A). It is shown that genes with their products in the same protein complex have significantly higher scores (U=3,425.5, p<2.2e−16; FIG. 3B). Additionally, within-complex pairs are significantly enriched for higher scores for complexes of size <10 proteins (U=3,114,511.5, p<0.0001), and complexes of all sizes (U=295,820,010, p<0.0001). As the size of the complexes increases, the distributions of within-complex gene pair scores shifts to a left skew, echoing the distribution of gene pairs not in complexes. The proportion of gene pairs that have products in the same complex is higher than expected by chance (p<0.0001, Fisher's exact test, all score cutoffs) (FIG. 3C).

Synthetic lethality can change between contexts; a gene pair that is SL in a cancer cell does not necessarily have the same property in healthy tissue. This can occur due to changes in protein expression, as well as activation or inactivation of protein pathways. S. cerevisiae and S. pombe are unicellular organisms; therefore, models based on these species will necessarily focus on high-level, context-free synthetic lethal predictions. As such, the initial predictions from the disclosed subject matter present all pairs that have synthetic lethal potential in their global connectivity patterns.

In order to explore context-specific SL pairs, human gene pairs with scores >0.85 are identified. Tissue- and cell-line-specific lists of SL pairs can then be created by removing a gene pair if that tissue is not known to express both gene products according to the well-known Human Protein Atlas. Although the number of proteins removed from the network is correlated with the number of SL pairs filtered from each given tissue or cell line, the number of filtered SL pairs can be, at times, lower or higher than expected by chance. For example, rectal tissue has approximately half as many SL pairs filtered out (70) as expected (146; OR=0.477, p=1.6e−5, Fisher's exact test). In contrast, tissue of the small intestine has over twice as many SL pairs filtered (1653) than expected (826; OR=2.11, p<2.2e−16, Fisher's exact test). Respiratory epithelial cells also have a high number of filtered SL pairs (0: 550, E: 280; OR=2.00, p<2.2e−16). The presence of higher- or lower-than-expected numbers of retained SL pairs indicates context-specific resistance or susceptibility to SL interactions.

SL prediction with SINa-TRA can be further compared to the Syn-Lethality database, which compiles experimentally identified human SL pairs, and the DAISY method, a technique for identifying SL pairs. The gene pairs from both datasets have significantly higher scores (Syn-Lethality: U=12,265, p<2.2e−16; DAISY (VHL): U=299, p=5.86e−6; DAISY (cancer): U=1992856, p<2.2e−16; FIG. 2E), compared to the median of untested pairs (0.122; 99% CI: [0.122,0.122]); DAISY's cancer predictions have a median score of 0.233 (99% CI: [0.225,0.243]); its VHL predictions have a median score of 0.255 (99% CI:[0.195,0.368]) and the Syn-Lethality dataset had a median score of 0.459 (99% CI: [0.397,0.514]).

SL gene pairs involving genetic deficiency, inactivation, or mutation can be selected from the Syn-Lethality database. Of the 88 pairs matching these criteria, all are included in the predicted network, and 34 of these have scores >0.5 (p=4.8e−11, Fisher's exact test), and 11 with scores >0.75 (p=0.0070, Fisher's exact test). Among the 2,816 gene pairs predicted to be SL specifically in cancer using DAISY, 2,576 pairs are in the predicted network; 151 pairs have scores >0.5 (p=7.5e−24, Fisher's exact test), and 14 pairs have scores >0.75 (p=0.00096, Fisher's exact test).

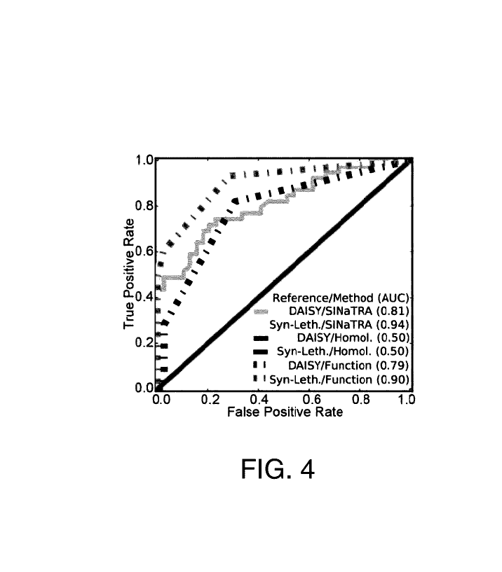

The presently disclosed subject matter is able to predict genes present in both the DAISY and Syn-Lethality datasets with AUCs of 0.73 and 0.93, respectively. (FIG. 4). In comparison, homology was not predictive in either dataset (AUC=0.50 for both; no homology data present for the pairs), unlike functional annotations (AUC=0.786, DAISY; AUC=0.904, Syn-Lethality). When the precision-recall curves of these data are considered, the disclosed subject matter in both datasets is found to outperform function in DAISY, while function in Syn-Lethality has similar performance.

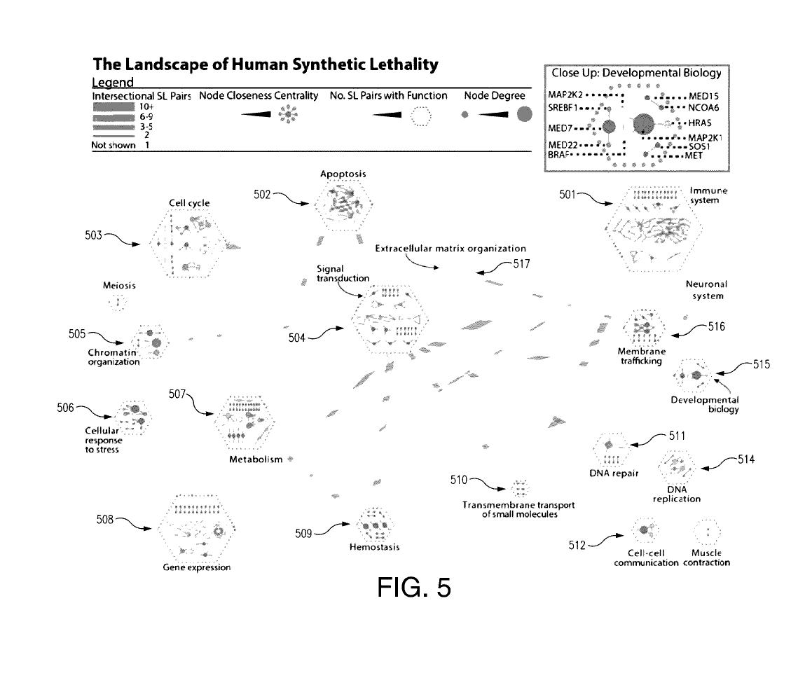

To further analyze the landscape of human synthetic lethality, 458 predicted SL genes pairs can be categorized using biological pathway data from Reactome and presented as a network diagram (FIG. 5), where hexagonal nodes represent pathways, and edges connect pathways when SL pairs are predicted between-pathway (i.e. with one member in each). 334 (73%) of these interactions are within-pathway and 124 (27%) are between-pathway (OR=3.69, p<0.0001, Fisher Exact Test). Among the within-pathway SL pairs, apoptosis 502, the immune system 501, and gene expression 508 have highly interconnected SL networks, indicated by low closeness centrality. The immune system 501 has the highest number of associated SL gene pairs (101); the most central of these is RIPK1, with 15 connections. Several functions have no associated SL pairs, including extracellular matrix organization 517, metabolism of proteins, and reproduction. These functions can have little functional redundancy that allows for SL to occur. Of the between-pathway SL pairs, each pair of pathways share an average of 2.8 SL pairs. The immune system/signal transduction between-pathway pairs are the most numerous (11 pairs).

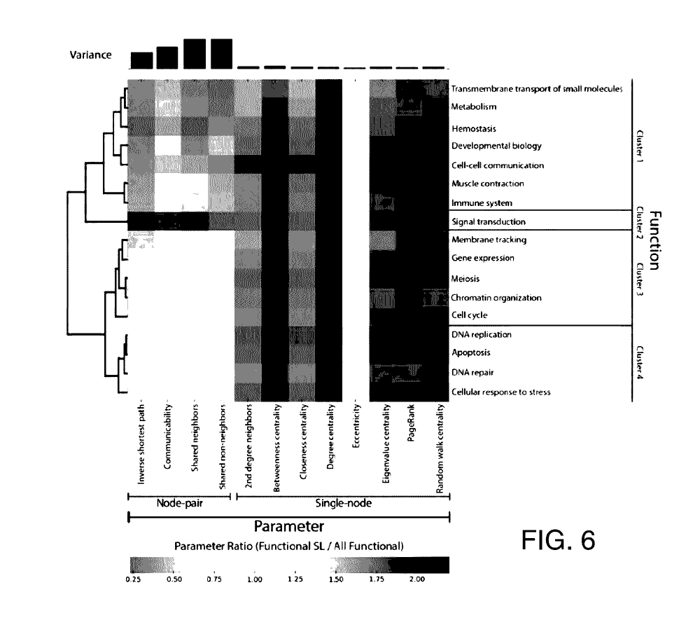

To further exam function-specific mechanisms of synthetic lethality, gene pairs can be grouped into 17 high-level Reactome functional categories and clustered them by their parameter values. It is found that pathway-specific parameter enrichment exists in node-pair parameters (inverse shortest path, communicability, shared neighbors, and shared non-neighbors), but not in single-node parameters, as evidenced by the increase in variance of paired parameters versus single-node parameters (FIG. 6). For example, the signal transduction pathway has higher values for node-pair parameters than other functions and all SL pairs. In contrast, apoptosis, DNA repair, and DNA replication have node-pair signals that are closer to the mean of all of its within-function pairs than other functions.

Each putative SL gene pair from these 17 functional categories can be annotated for three possible mechanisms: (1) complex, where the proteins products of the pair are known to form a complex, (2) parallel, where the proteins function in the same pathway with no known direct or indirect interaction, and (3) other, for gene pairs that do not fit in (1) or (2). In total there were 5,249 putative SL gene pairs for the 17 categories. Most of these pairs were in the same complex (56.2%, N=2,950), followed by parallel (24.0%, N=1,260) and other (19.8%, N=1,039). Each function category can be tested for enrichments for particular mechanisms of SL. It is found that each function has different proportions of putative mechanistic annotations. Immune system (OR=1.48, p=0.000001) and signal transduction (OR=1.42, p=0.000894) are significantly enriched for SL genes that function in parallel, after multiple hypothesis correction (Table 4). Four categories are enriched for SL genes that are components in complexes: gene expression (OR=1.38, p=0.000298), meiosis (OR=4.31, p=0.046), chromatin organization (OR=2.10, p=0.008499), and DNA repair (OR=4.76, p<2.2e−16) (Table 4).

TABLE 4

| | | Other | | |
|---|---|---|---|---|
| Function | Complex | (Count/OR) | Parallel | Cluster |
| Transmembrane | 52/2.04† | 8/0.5 | 12/0.63 | Cluster 1 |
| transport of small | | | | |
| Metabolism | 330/1.04 | 86/0.681 | 162/1.271 | |
| Hemostasis | 86/0.75 | 44/1.39 | 44/1.07 | |
| Developmental | 191/1.13 | 70/1.13 | 62/0.741 | |
| biology | | | | |
| Cell-cell | 20/1.2 | 8/1.3 | 5/0.56 | |
| communication | | | | |
| Muscle contraction | 2/0.221 | 5/5.081 | 2/0.9 | |
| Immune system | 606/0.64* | 286/1.251 | 377/1.48* | |
| Signal transduction | 352/0.55* | 213/1.58* | 239/1.42* | Cluster 2 |
| Membrane trafficking | 711.511 | 18/0.81 | 19/0.67 | Cluster 3 |
| Gene expression | 572/1.37* | 143/0.711 | 199/0.86 | |
| Meiosis | 22/4.311 | 3/0.53 | 1/0.131 | |
| Chromatin | 77/2.11 | 9/0.371 | 20/0.73 | |
| organization | | | | |
| Cell cycle | 124/1.481 | 46/1.31 | 20/0.36* | |
| DNA replication | 96/1.541 | 6/0.17* | 43/1.35 | Cluster 4 |
| Apoptosis | 124/1.481 | 46/1.31 | 20/0.36* | |
| DNA repair | 124/4.76* | 15/0.46 | 6/0.13* | |
| Cellular responses | 101/1.27 | 33/1.03 | 29/0.68 | |
| to stress | | | | |

Further, Cluster 1 (FIG. 6), which includes transmembrane transport, metabolism, hemostasis, developmental biology, cell-cell communication, muscle contraction, and the immune system, is significantly enriched for SL genes that function in parallel (OR=1.36, p=0.00008).

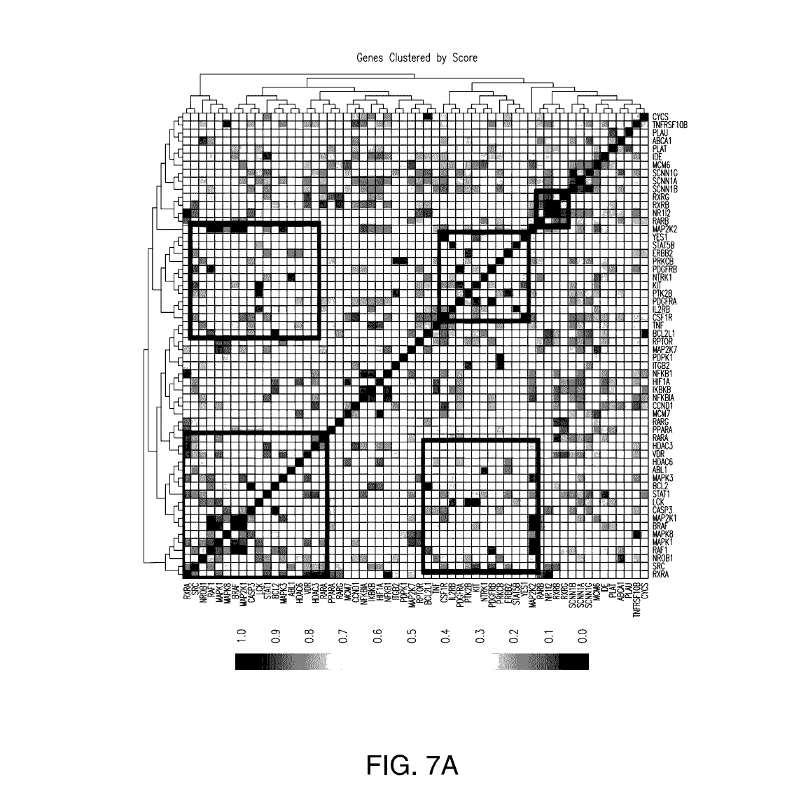

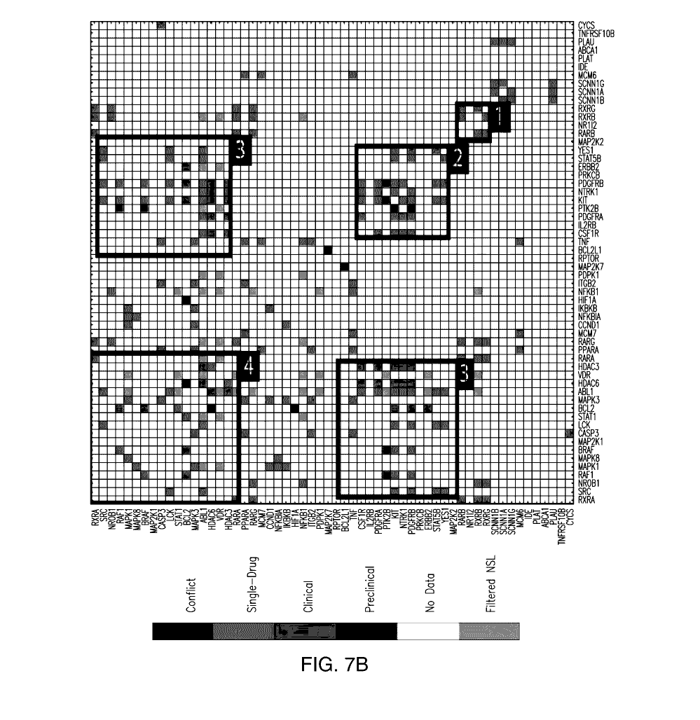

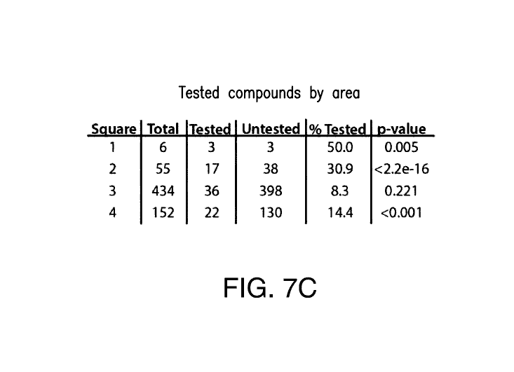

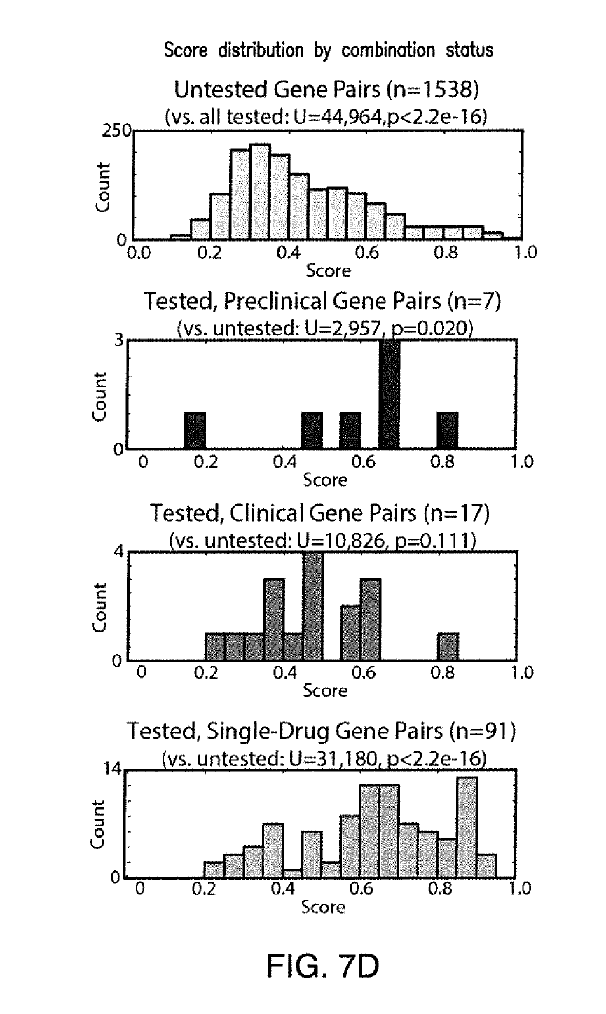

The putative synthetic lethal pairs can be useful in developing novel cancer therapies. For example, 58 unique genes are identified from high-scoring gene pairs (score >0.85) where both members were targets of cancer therapies (68 unique drugs). These genes were clustered by score (FIG. 7A) using hierarchical clustering; areas of high and low scores are observed. It is shown that gene pairs that are targeted by drugs have significantly higher scores than those that are not; median score increases significantly from pairs that are targeted by only one drug (median score=0.156), to those targeted by two drugs (median score=0.166), to those targeted by only one cancer drug (median score=0.211), to those targeted by two cancer drugs (median score=0.283). The gene pairs that are filtered out through co-mutation analysis, as well as those linked to single-drug therapies, drug combination therapies in the clinical pipeline can be further identified. These data are overlaid on the heat map (FIG. 7B). It is shown that gene pairs targeted by cancer drugs have significantly higher scores than filtered pairs and pairs not under investigation (FIG. 7D; U=44,964, p<0.0001, Mann-Whitney U test). “Hotspots” of drug combinations (black boxes, FIG. 7A and FIG. 7B) that correspond to gene pairs with high scores (FIG. 6C) can be visually identified. For example, Area 1 contains genes related to gene expression (p=0.040), transcription initiation from RNA poly-merase II promoter (p=0.025), and steroid hormone receptor activity (p=0.025; Fisher's exact test with multiple hypothesis testing). In addition, Area 2 is associated with protein autophosphorylation (OR=39.1, p=0.000613; Fisher's exact test). Areas 3 and 4 are not significantly associated with any GO terms.

As a further example of the disclosed subject matter for application in cancer treatment, analysis of Area 2 identifies five genes with products that are inhibited fairly specifically by approved drugs, or compounds in development: CSF 1R (BLZ945), ERBB2 (Mubitrinab), KIT (Amuvatinib), PTK2B (PF-431396), and STAT5B (STATS Inhibitor). Scores for all possible pairs (n=10) range between 0.88 and 0.442.

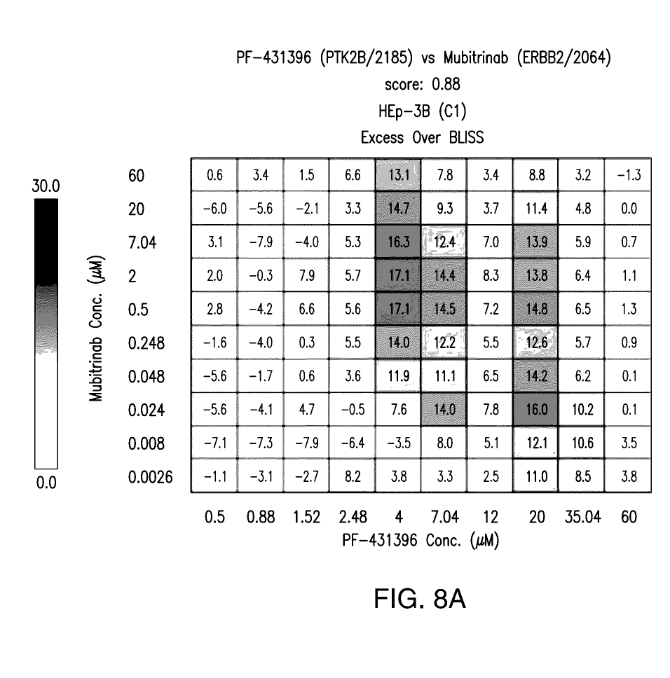

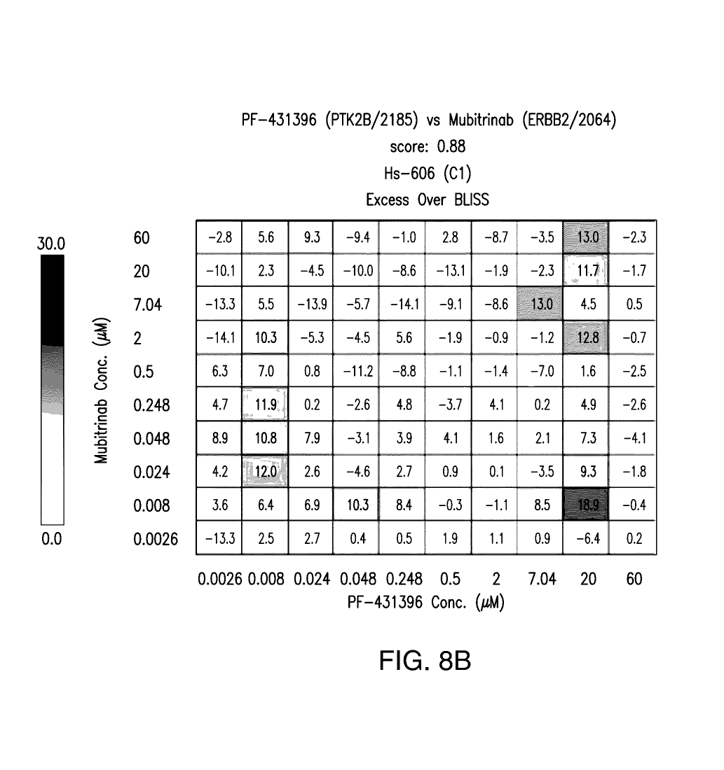

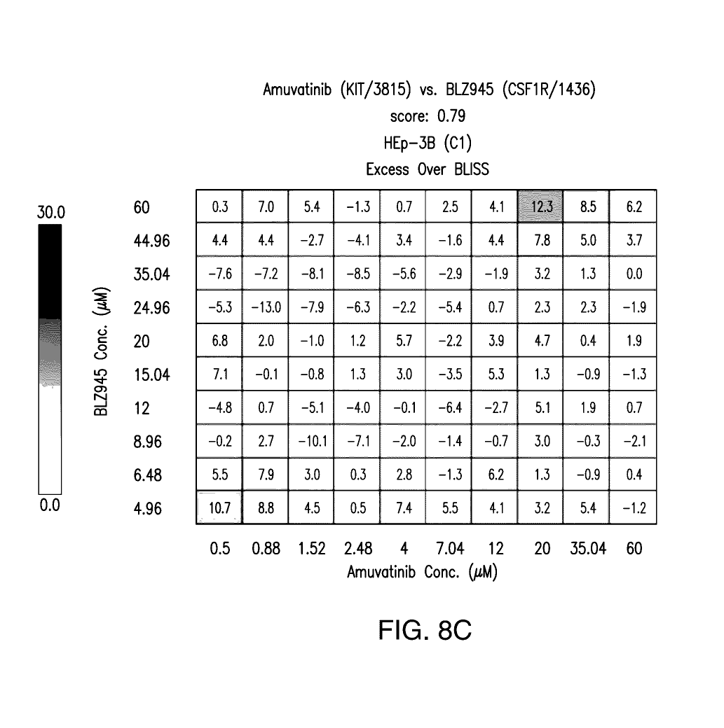

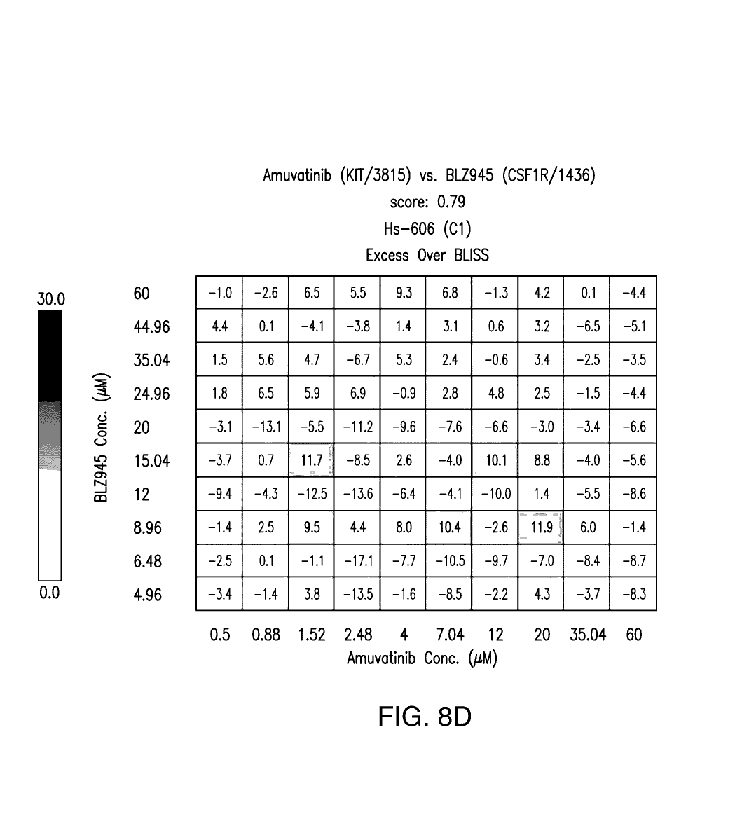

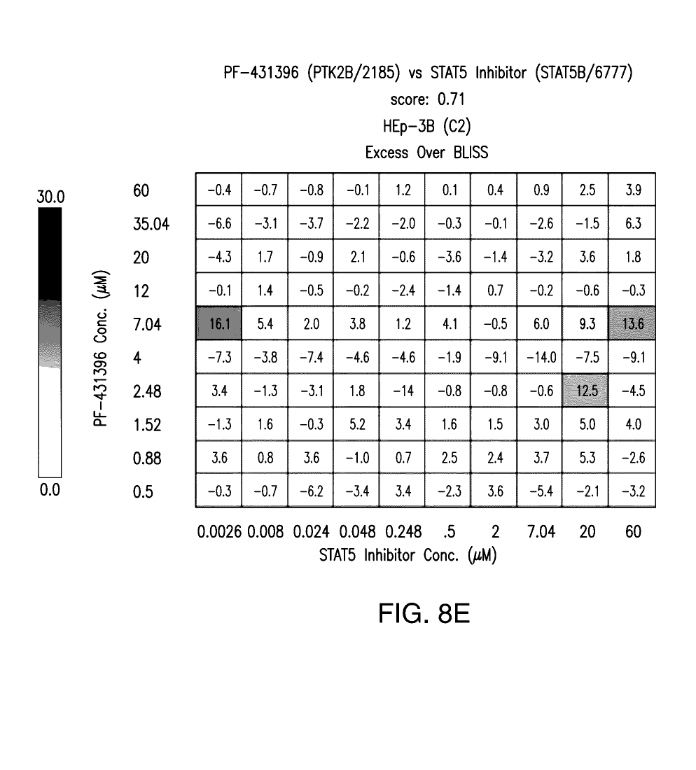

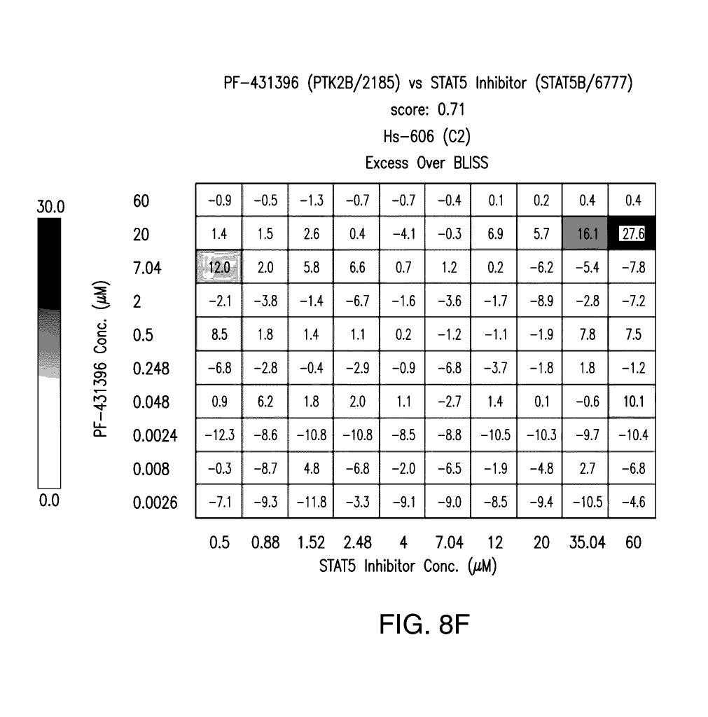

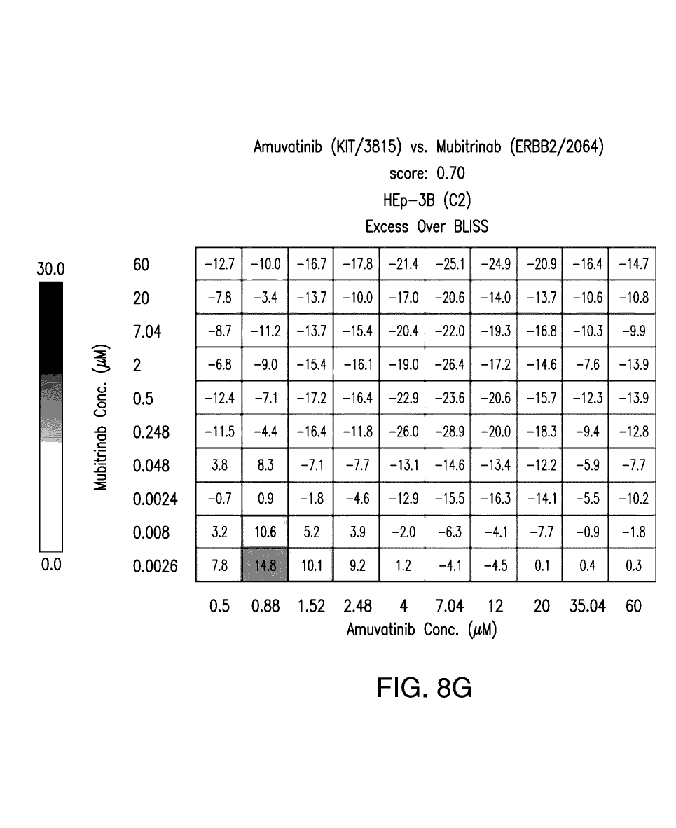

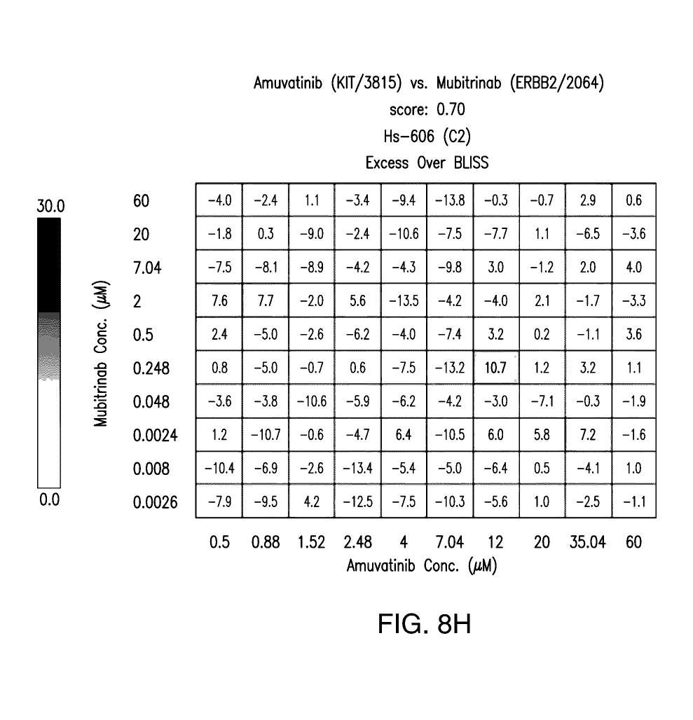

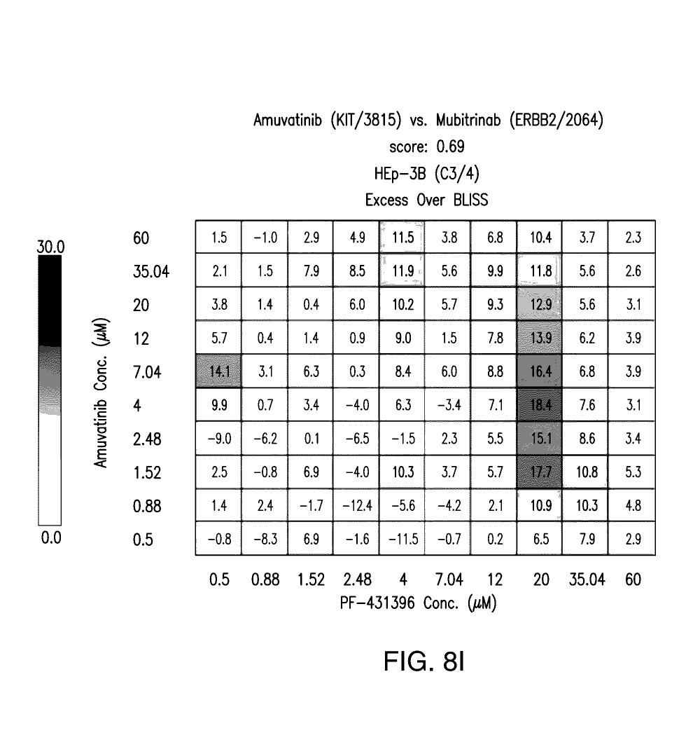

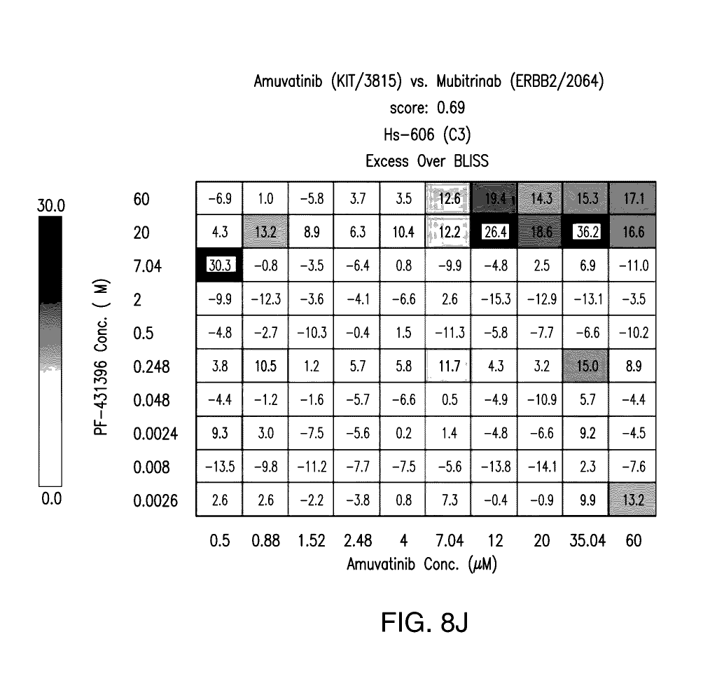

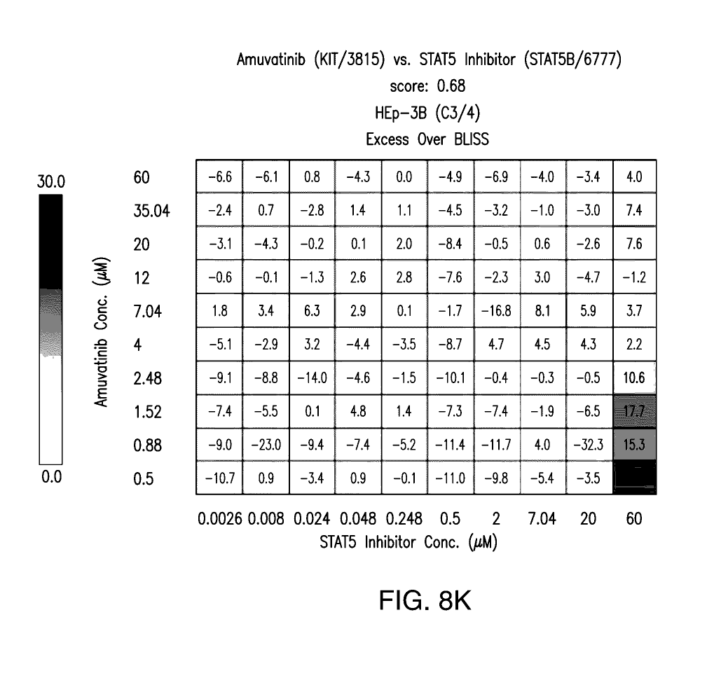

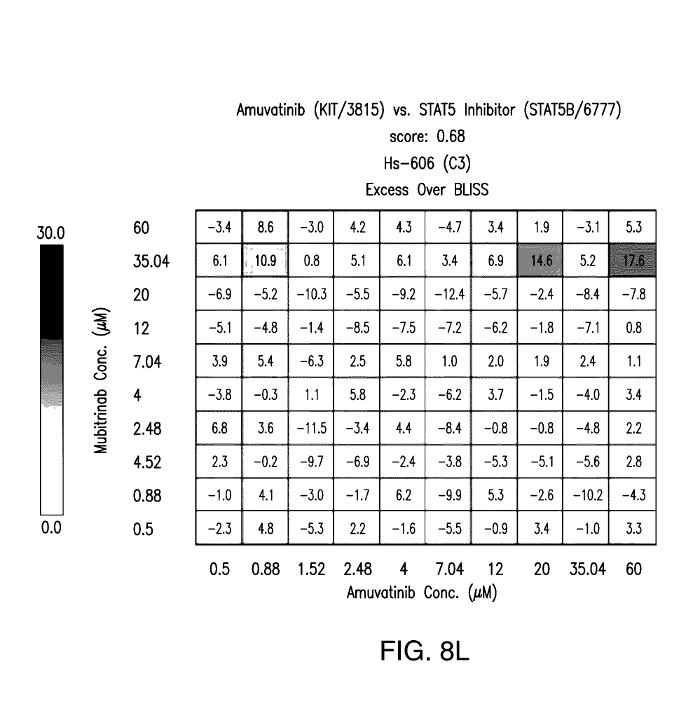

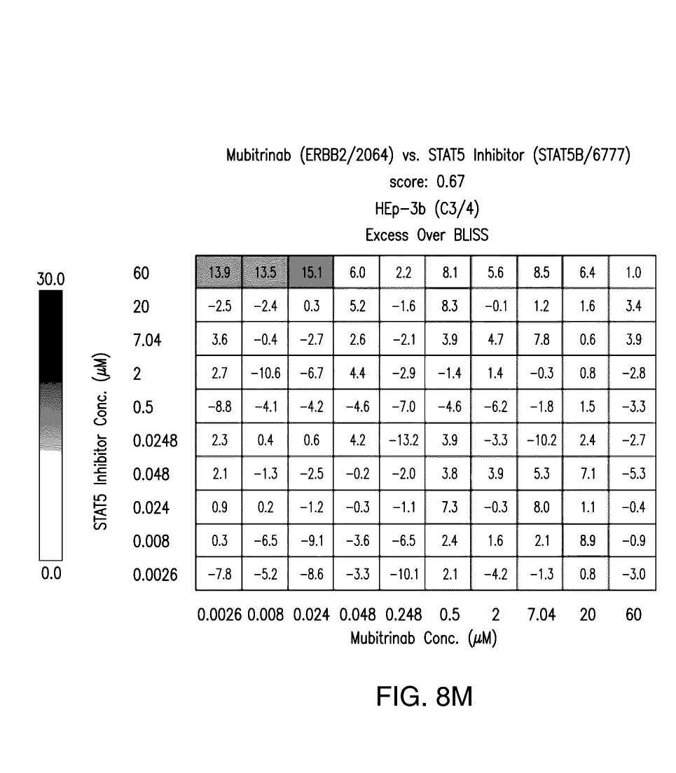

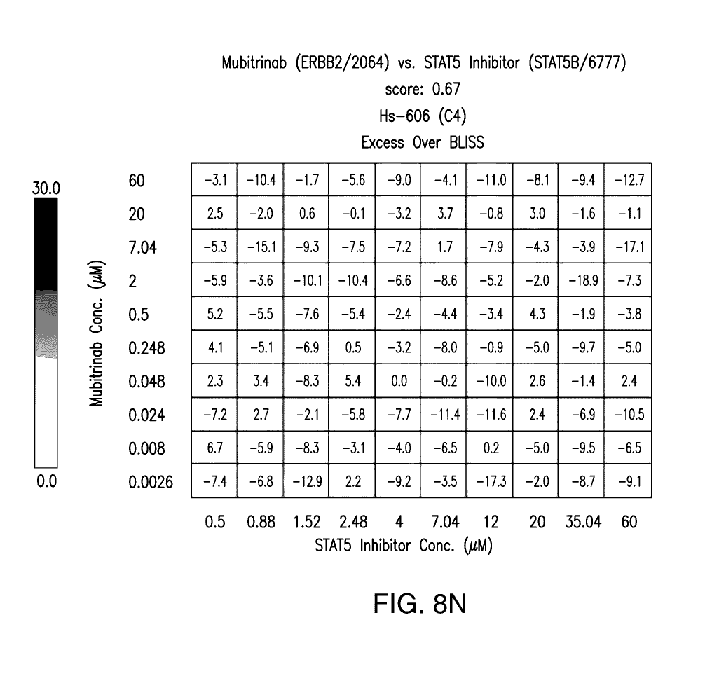

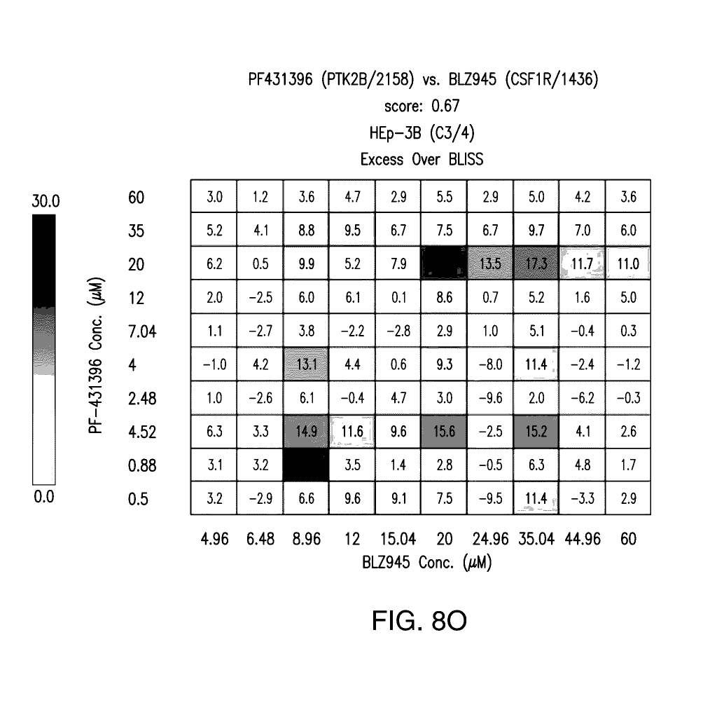

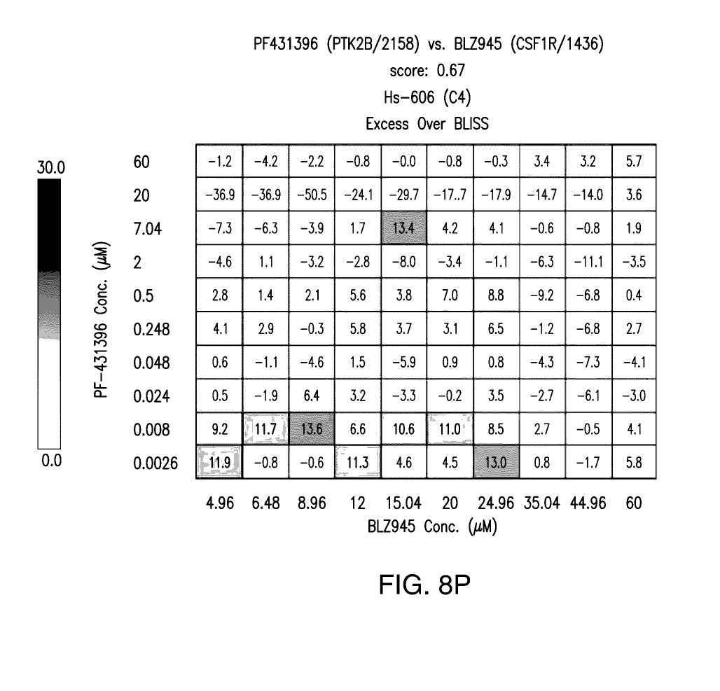

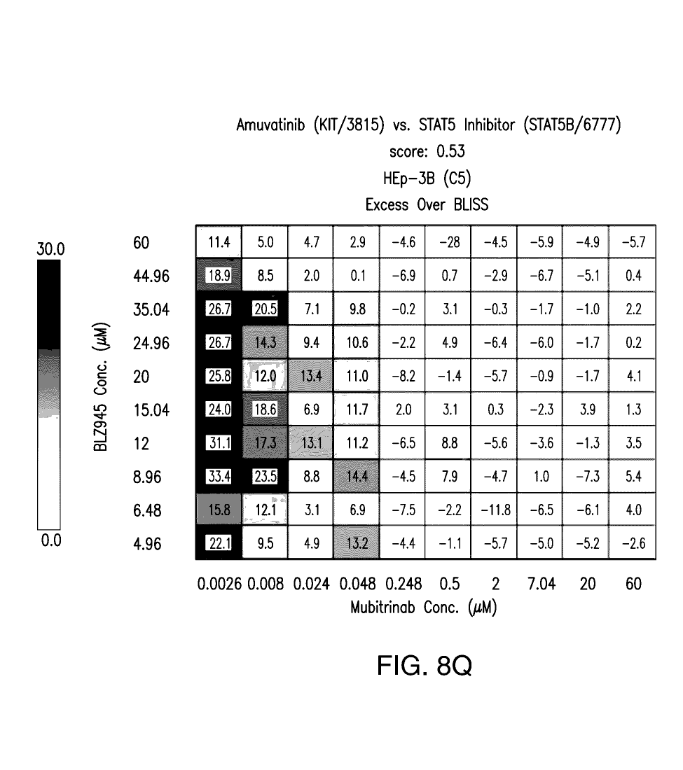

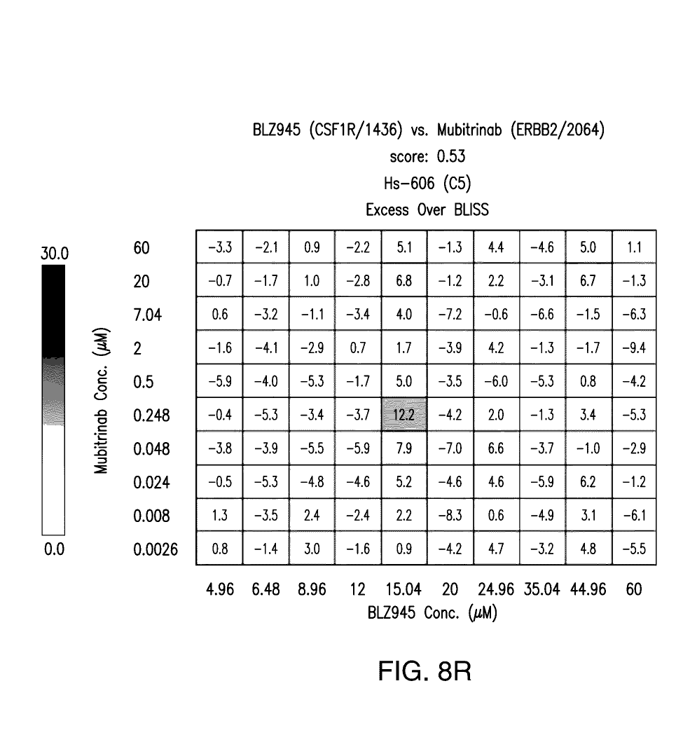

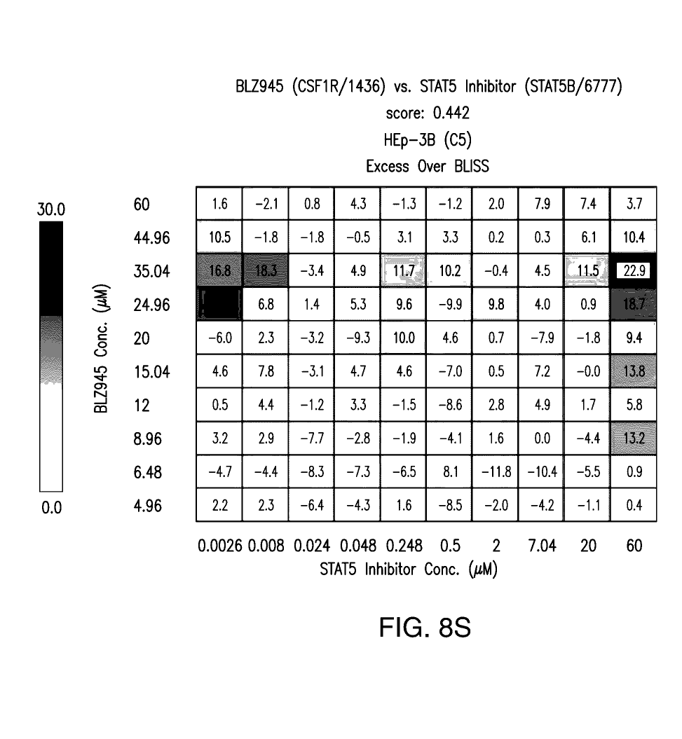

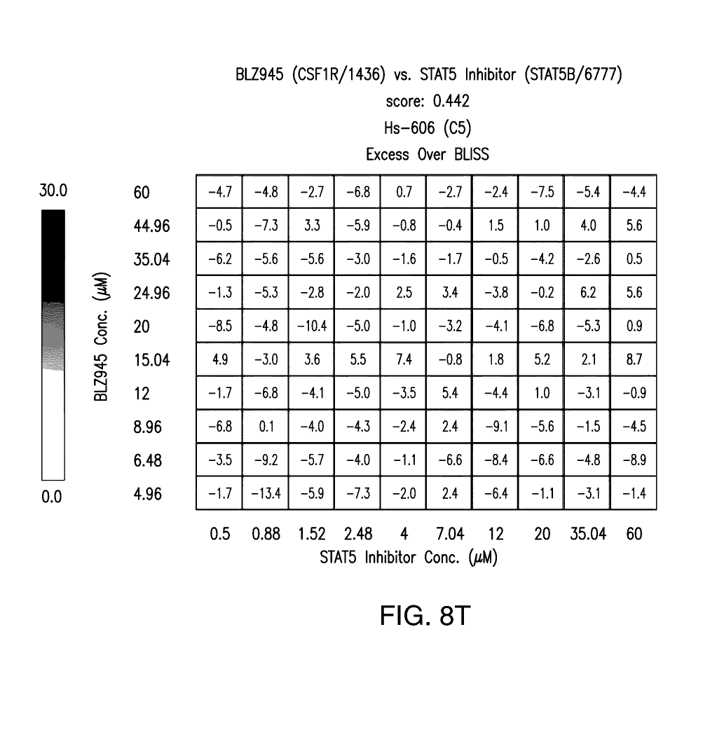

The Cancer Cell Line Encyclopedia can be used to identify cell lines, where these genes of interest are over-expressed. For example, Hep-3B and Hs606 are two of such cell lines. Drug synergy between each gene pair is then identified using Excess Over BLISS, and show good correlation with score. (FIG. 8A-FIG. 8T) Synergy appears to exist between PTK2B and ERBB2 (Score=0.88) and CSF1R/ERBB2 (Score=0.53), a true positive rate of 0.22.

As another example, all filtered gene pairs with scores ≧0.95 can be mapped to drug(s) that target its product based on DrugBank. Of the 1,308 gene pairs meeting the score threshold, 208 pairs contain at least one gene that maps to at least one drug and eighteen pairs have both gene members mapping to drugs. This result further assists identification of novel cancer treatment drugs.

The description herein merely illustrates the principles of the disclosed subject matter. Various modification and alterations to the described embodiments will be apparent to those skilled in the art in view of the teachings herein. Accordingly, the disclosure herein is intended to be illustrative, but not limiting, of the scope of the disclosed subject matter.

1. A method for predicting synthetic lethality in a first species using experimentally derived synthetic lethality data of at least a second species, comprising:
generating a first biological network for the first species and a second biological network for the second species, wherein each of the first and second biological networks includes node information representing genes and edge information representing physical interactions between gene-protein products;
determining one or more network parameters of the first and second biological networks;
normalizing the one or more network parameters to permit comparisons between the first and second biological networks;
training a synthetic lethality model with the experimentally derived synthetic lethality data; and
applying the synthetic lethality model to the first biological network to predict one or more synthetic lethality pairs.

2. The method of claim 1, wherein the training further comprises:
selecting one or more synthetic lethality pairs and one or more non-synthetic lethality pairs based on the experimentally derived synthetic lethality data;
modeling synthetic lethality from the selected pairs using random forest classification; and
cross-validating the modeling.

3. The method of claim 1, wherein the normalizing comprises rank-normalization of the one or more network parameters.

4. The method of claim 1, wherein the first and second biological networks comprise protein-protein interaction networks.

5. The method of claim 1, wherein the second species is S. cerevisiae.

6. The method of claim 1, wherein the first species is S. pombe.

7. The method of claim 1, wherein the first species is Mus musculus.

8. The method of claim 1, wherein the first species is human.

9. The method of claim 8 further comprises filtering synthetic lethality pairs to generate context specific synthetic lethality based on protein expression data of a given context.

10. A method for selecting cancer drug treatment for a patient comprising:
selecting at least a source species with experimentally derived synthetic lethality data;
generating a first biological network for the source species and a second biological network for the patient, wherein each of the first and second networks includes node information representing genes and edge information representing physical interactions between gene-protein products;
determining one or more network parameters of the first and second biological networks;
normalizing the one or more network parameters to permit comparisons between the first and second biological networks;
training a synthetic lethality model with the experimentally derived synthetic lethality data of the source species;
applying the synthetic lethality model to the second biological network to predict one or more synthetic lethality pairs;
filtering the one or more synthetic lethality pairs to generate one or more context specific synthetic lethality pairs based on protein expression data of a cancer cell line targeted by the cancer therapy; and
choosing one or more drugs that target gene expression products of at lease one of the one or more context specific synthetic lethality pairs.

11. The method of claim 10, wherein the first and second biological networks comprise protein-protein interaction networks.

12. The method of claim 10, wherein the training further comprises:
selecting one or more synthetic lethality pairs and one or more non-synthetic lethality pairs based on the experimentally derived synthetic lethality data;
modeling synthetic lethality from the selected pairs using random forest classification; and
cross-validating the modeling.

13. The method of claim 10, wherein the source species is S. cerevisiae.

14. The method of claim 10, wherein the one or more context specific synthetic lethality pairs are over-expressed in the cancer cell line.

15. One or more drugs for targeted cancer treatment of a patient having a second biological network, selected using at least a source species having a first biological network and experimentally derived synthetic lethality data,
wherein each of the first and second networks includes node information representing genes and edge information representing physical interactions between gene-protein products, one or more determined network parameters normalized to permit comparisons therebetween;
wherein a trained synthetic lethality model applied to the second biological network corresponds to one or more context specific synthetic lethality pairs based on protein expression data of a cancer cell line related to the patient, such that the one or more drugs are adapted to target gene expression products of at least one of the one or more context specific synthetic lethality pairs.

15. The one or more drugs of claim 14, wherein the at least one of the one or more context specific synthetic lethality pairs are over-expressed in the cancer cell line.

16. The one or more drugs of claim 14 further exhibit drug synergy between genes of the at least one of the one or more context specific synthetic lethality pairs.
